(19) United States
(12) Patent Application Publication
(10) Pub. No.: US 2007/0259567 A1
(43) Pub. Date: Nov. 8, 2007

(54) Multiple mode micro memory card connector

(76) Inventors: Li-Pai Chen, Taipei City (TW); Ming-Dar Chen, Hsinchu City (TW); Hsiang-An Hsieh, Keelung City (TW); Jui-Bin Hwan, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/382,268

(22) Filed: May 8, 2006

(51) Int. Cl. H01R 33/00

(52) U.S. Cl. 439/638

(57) ABSTRACT

A multiple mode micro memory card connector includes a housing and a cavity formed in the housing for receiving a micro memory card. The cavity includes a first end having a shape conforming to a first device connection standard for receiving a micro memory card compatible with the first device connection standard, and a second end formed at an opposite end of the cavity from the first end, the second end having a shape conforming to a second device connection standard for receiving a micro memory card compatible with the second device connection standard.

### BACKGROUND OF THE INVENTION

1. Field of the Invention

The present invention relates to a multiple mode micro memory card connector, and more particularly, to a multiple mode micro memory card connector for receiving multiple types of micro memory cards.

2. Description of the Prior Art

As personal electronic devices become smaller and more sophisticated, the need for small sized memory cards becomes greater. As a result, micro sized flash memory cards have entered the market, and are used for miniature electronic devices that require swappable memory cards.

Please refer to FIGS. 1 and 2. FIG. 1 is a front view of a MMCmicro™ memory card 10 according to the prior art. FIG. 2 is a front view of a microSD™ memory card 20 according to the prior art. Both the MMCmicro memory card 10 and the microSD memory card 20 are considered to be micro-sized flash memory cards. Unfortunately, the MMCmicro memory card 10 must be read through a MMCmicro connector, and cannot be read by a microSD connector. The same problem exists for the microSD memory card 20, which cannot be read by a MMCmicro connector.

Therefore, although the MMCmicro memory card 10 and the microSD memory card 20 have a similar size, their incompatibility causes problems for users, who must ensure that memory cards and connectors match each other.

### SUMMARY OF THE INVENTION

It is therefore an objective of the claimed invention to provide a multiple mode micro memory card connector being compatible with MMCmicro memory cards, microSD memory cards, and a new micro memory card format that combines both of the MMCmicro and microSD memory cards in order to solve the above-mentioned problems.

According to an exemplary embodiment of the claimed invention, a multiple mode micro memory card connector is disclosed. The multiple mode micro memory card connector includes a housing and a cavity formed in the housing for receiving a micro memory card. The cavity includes a first end having a shape conforming to a first device connection standard for receiving a micro memory card compatible with the first device connection standard, and a second end formed at an opposite end of the cavity from the first end, the second end having a shape conforming to a second device connection standard for receiving a micro memory card compatible with the second device connection standard.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a front view of a MMCmicro™ memory card according to the prior art.

FIG. 2 is a front view of a microSD™ memory card according to the prior art.

FIG. 3 is a front view of a multiple mode micro memory card.

FIG. 4 is a perspective front view of the multiple mode micro memory card.

FIG. 5 is a perspective rear view of the multiple mode micro memory card.

FIG. 6 is a rear view of the multiple mode micro memory card showing pad numbers for the first set of contact pads and the second set of contact pads.

FIG. 7 is a table describing the functions of contact pads on the multiple mode micro memory card when the multiple mode micro memory card is operated in different modes.

FIG. 8 is a perspective front view of a multiple mode micro memory card connector according to the present invention.

FIG. 9 and FIG. 10 are front and rear views of the multiple mode micro memory card connector, respectively.

FIG. 11 is a view of the top edge of the multiple mode micro memory card connector as shown in FIG. 9.

FIG. 12 is a view of the bottom edge of the multiple mode micro memory card connector as shown in FIG. 9.

FIG. 13 and FIG. 14 are left and right side views of the multiple mode micro memory card connector as shown in FIG. 9.

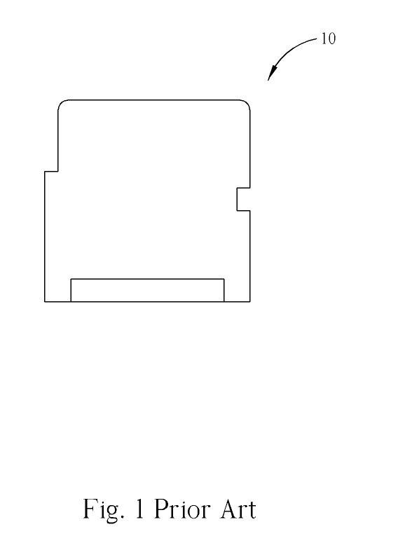

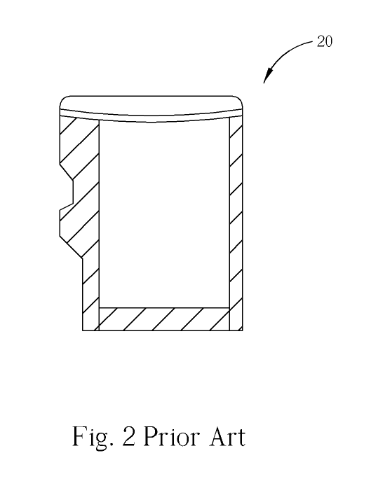

### DETAILED DESCRIPTION

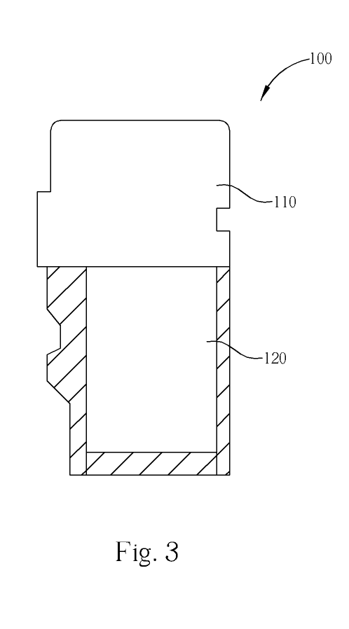

Please refer to FIG. 3. FIG. 3 is a front view of a multiple mode micro memory card 100. The multiple mode micro memory card 100 contains a first housing 110 integrally joined with a second housing 120 to form an integrated housing. The first housing 110 is formed at a first end of the multiple mode micro memory card 100 and conforms to the MMCmicro memory card standard, whereas the second housing 120 is formed at a second end of the multiple mode micro memory card 100 and conforms to the microSD memory card standard. In addition, the multiple mode micro memory card 100 creates a new memory card standard that utilizes both the first housing 110 and the second housing 120 for reading and writing data. As a result, the multiple mode micro memory card 100 is compatible with three different micro memory card form factors: the MMCmicro memory card standard, the microSD memory card standard, and the form factor of the new multiple mode micro memory card 100.

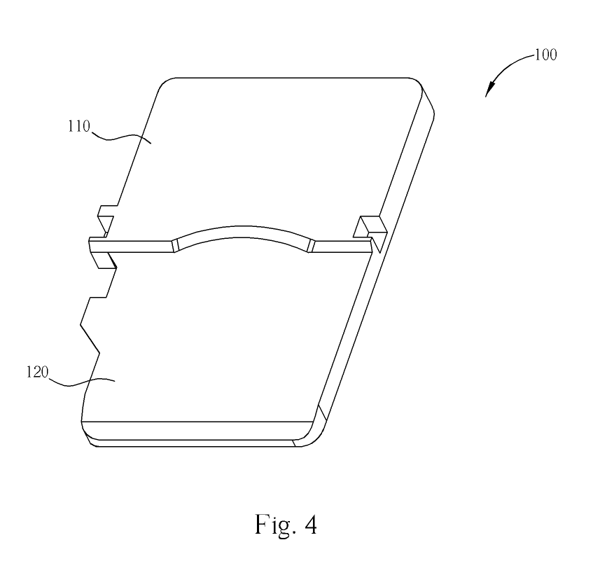

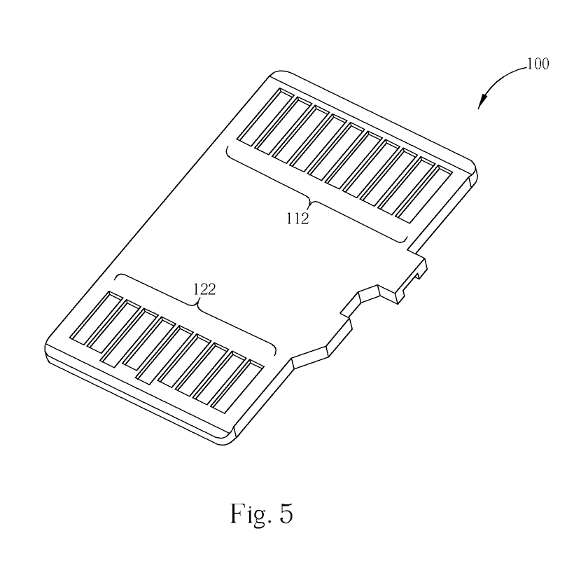

Please refer to FIGS. 4 and 5. FIG. 4 is a perspective front view of the multiple mode micro memory card 100. As shown, the first housing 110 has a greater thickness and a larger width than that of the second housing 120. This is due to the different dimensions of the MMCmicro memory card and microSD memory card form factors. FIG. 5 is a perspective rear view of the multiple mode micro memory card 100. The first housing 110 contains a set of ten first contact pads 112 and the second housing 120 contains a set of eight second contact pads 122, in accordance with both the MMCmicro memory card standard and the microSD memory card standard.

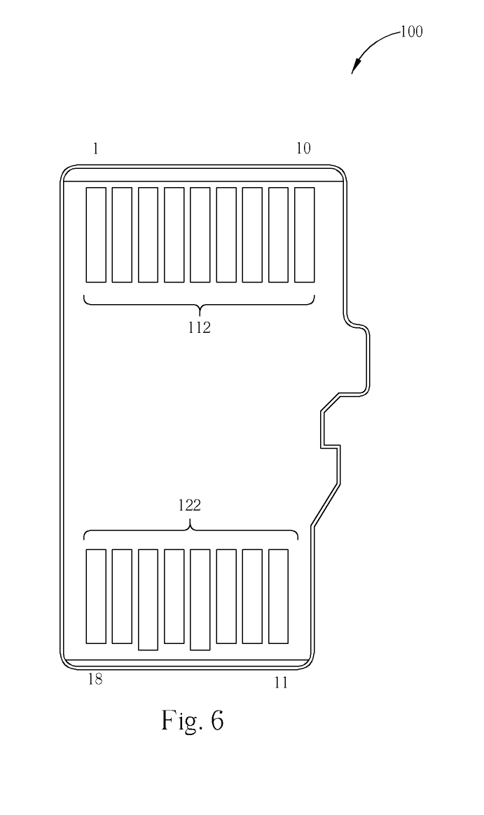

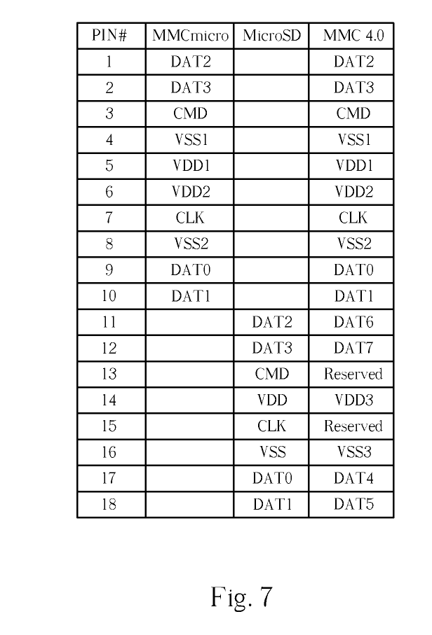

Please refer to FIG. 6 and FIG. 7. FIG. 6 is a rear view of the multiple mode micro memory card 100 showing pad numbers for the first set of contact pads 112 and the second set of contact pads 122. The first set of contact pads 112 are numbered from 1-10 and the second set of contact pads 122 are numbered from 11-18. FIG. 7 is a table describing the functions of contact pads on the multiple mode micro memory card 100 when the multiple mode micro memory card 100 is operated in different modes. When the multiple mode micro memory card 100 is operated according to either the MMCmicro memory card standard or the microSD memory card, a total of four data contact pads (DAT0-DAT3) are used for reading and writing data. However, when both the first set of contact pads 112 and the second set of contact pads 122 are used, the multiple mode micro memory card 100 is able to conform to the MMC 4.0 standard, and utilizes 8 data contact pads (DAT0-DAT7). Therefore, the multiple mode micro memory card 100 provides the ability to have twice the data throughput if both the first set of contact pads 112 and the second set of contact pads 122 are used for reading or writing data.

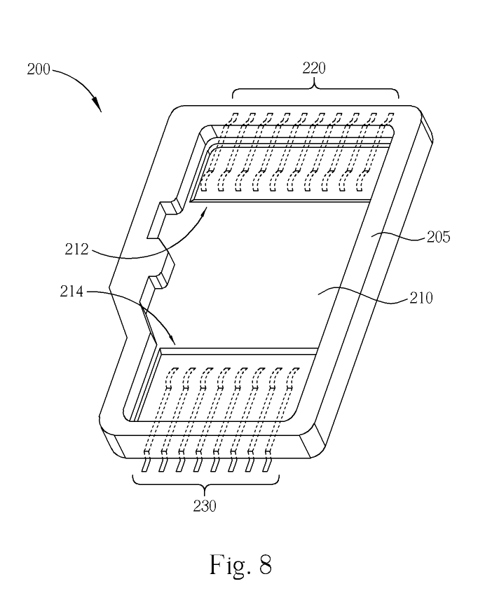

Please refer to FIG. 8. FIG. 8 is a perspective front view of a multiple mode micro memory card connector 200 according to the present invention. The multiple mode micro memory card connector 200 contains a housing 205 and a cavity 210 formed in the housing 205. The cavity 210 contains a first end 212 and a second end 214 opposite the first end 212. The first end 212 contains a first set of contact terminals 220 containing 10 contact terminals and the second end 214 contains a second set of contact terminals 230 containing 8 contact terminals. The first end 212 is shaped according to the MMCmicro memory card standard for receiving a MMCmicro memory card, and uses the first set of contact terminals 220 for communicating with the MMCmicro memory card. Similarly, the second end 214 is shaped according to the microSD memory card standard for receiving a microSD memory card, and uses the second set of contact terminals 230 for communicating with the microSD memory card. In addition, the multiple mode micro memory card connector 200 is also capable of receiving the multiple mode micro memory card 100 shown in FIGS. 3-6. In this case, the multiple mode micro memory card 100 communicates with the multiple mode micro memory card connector 200 using both the first set of contact terminals 220 and the second set of contact terminals 230.

Therefore, the multiple mode micro memory card connector 200 is capable of reading micro memory cards having three different form factors: the MMCmicro memory card standard, the microSD memory card standard, and the form factor of the multiple mode micro memory card 100. As explained above with respect to FIGS. 6 and 7, when the multiple mode micro memory card connector 200 reads the multiple mode micro memory card 100, 8 contact terminals of the multiple mode micro memory card connector 200 are used to transfer data to and from the multiple mode micro memory card 100. On the other hand, only 4 contact terminals of the multiple mode micro memory card connector 200 are used to transfer data to and from either the MMCmicro memory card or the microSD memory card.

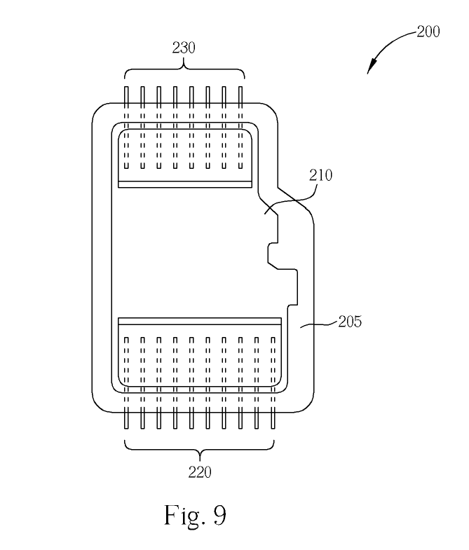

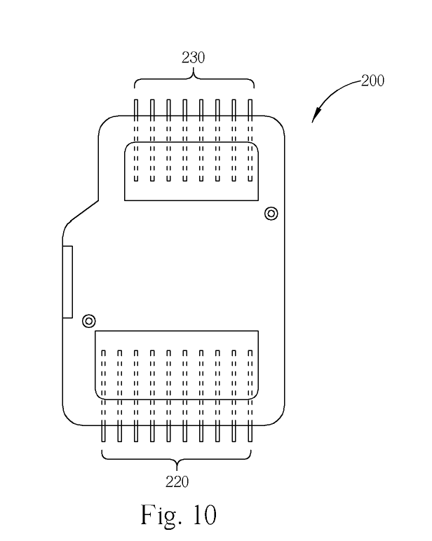

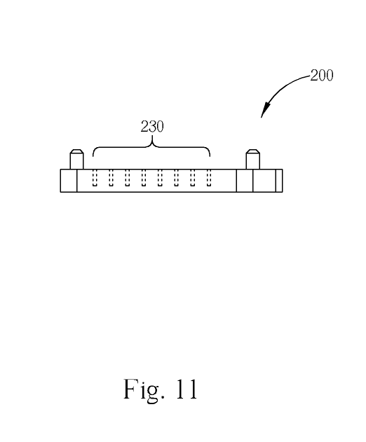

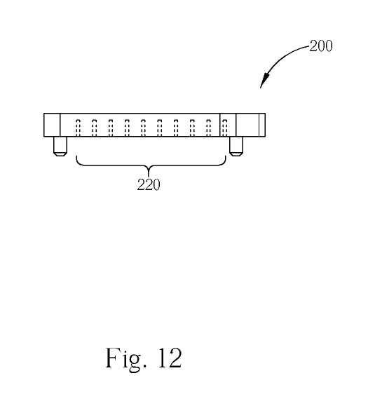

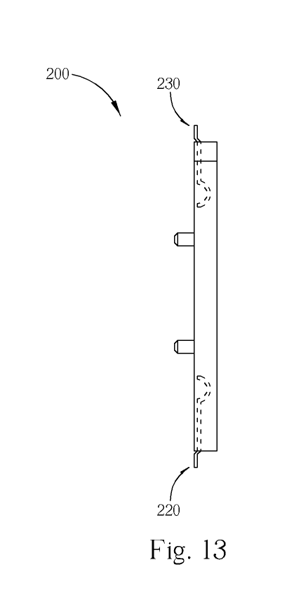

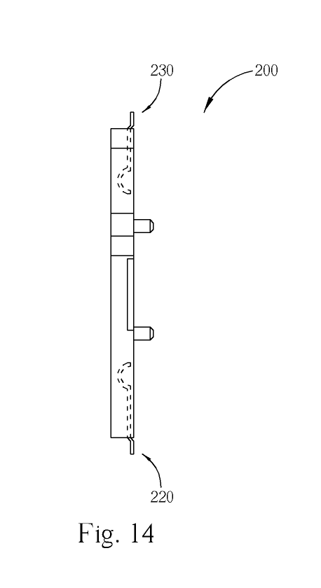

Please refer to FIGS. 9-14. FIG. 9 and FIG. 10 are front and rear views of the multiple mode micro memory card connector 200, respectively. FIG. 11 is a view of the top edge of the multiple mode micro memory card connector 200 as shown in FIG. 9, and FIG. 12 is a view of the bottom edge of the multiple mode micro memory card connector 200 as shown in FIG. 9. FIG. 13 and FIG. 14 are left and right side views of the multiple mode micro memory card connector 200 as shown in FIG. 9.

The multiple mode micro memory card 100 is preferably inserted into the cavity 210 of the multiple mode micro memory card connector 200 from a top of the multiple mode micro memory card connector 200, although side insertion is also possible. The multiple mode micro memory card 100 is held in place in the cavity 210 of the multiple mode micro memory card connector 200 with a cover, and the cover may have a latching mechanism for latching with the multiple mode micro memory card connector 200 or may have a slide cover similar to that used to hold a subscriber identity module (SIM) card in place on a mobile phone. The cover is able to accommodate the dual-thickness feature of the multiple mode micro memory card 100.

In summary, the present invention multiple mode micro memory card connector 200 is compatible with both the MMCmicro memory card standard and the microSD memory card standard. In addition, the multiple mode micro memory card 100 can also be utilized for receiving multiple mode micro memory cards 100. The multiple mode micro memory card connector 200 can therefore receive three different types of memory cards, providing it with great versatility.

Those skilled in the art will readily observe that numerous modifications and alterations of the device and method may be made while retaining the teachings of the invention. Accordingly, the above disclosure should be construed as limited only by the metes and bounds of the appended claims.

1. A multiple mode micro memory card connector for connecting with at least one micro memory card, comprising:
a housing; and
a cavity formed in the housing, the cavity comprising:
a first end comprising a first set of contact terminals conforming to a first device connection standard; and
a second end formed at an opposite end of the cavity from the first end, the second end comprising a second set of contact terminals conforming to a second device connection standard.
wherein said micro memory card connector connecting with said memory card electrically through one or both of said first set of contact terminals and second set of contact terminals.

2. (canceled)

3. The multiple mode micro memory card connector of claim 1, wherein the first set of contact terminals comprises ten contact terminals and the second set of contact terminals comprises eight contact terminals.

4. The multiple mode micro memory card connector of claim 1, wherein the first device connection standard is a MMCmicro standard and the second device connection is a microSD standard.

5. The multiple mode micro memory card connector of claim 1, wherein said connector further comprising at least two alignment pins connected with said housing.

6. The multiple mode micro memory card connector of claim 1, wherein said first end having a shape conforming to a first device connection standard, and said second end having a shape conforming to a second device connection standard.

7. The multiple mode micro memory card connector of claim 1, wherein said first device connection standard was different from said second device connection standard.

8. The multiple mode micro memory card connector of claim 1, wherein said connector further comprising a cover for holding said memory card.

9. The multiple mode micro memory card connector of claim 6, wherein said cover further comprising a latching mechanism for latching with said memory card connector.

10. The multiple mode micro memory card connector of claim 1, wherein said connector further comprising a slide cover for holding said memory card.

11. A system comprising a multiple mode micro memory card connector connecting with at least one micro memory card, said memory card connector comprising:
a housing; and
a cavity formed in the housing, the cavity comprising:
a first end comprising a first set of contact terminals conforming to a first device connection standard; and
a second end formed at an opposite end of the cavity from the first end, the second end comprising a second set of contact terminals conforming to a second device connection standard;
wherein said micro memory card connecting with said memory card connector electrically through one or both of said first set of contact terminals and second set of contact terminals.
